(19) United States
(12) Patent Application Publication
(10) Pub. No.: US 2018/0171199 A1
(43) Pub. Date: Jun. 21, 2018

(54) NANOFIBRILLATED CELLULOSE FOR USE IN FLUIDS FOR PRIMARY OIL RECOVERY

(71) Applicant: ELKEM AS, Oslo (NO)

(72) Inventor: Mohamed AL-BAGOURY, Kristiansand S (NO)

(21) Appl. No.: 15/577,109

(22) PCT Filed: May 27, 2016
(86) PCT No.: PCT/NO2016/050109

§ 371 Date: Nov. 27, 2017

(30) Foreign Application Priority Data
May 29, 2015 (NO) 20150690

(51) Int. Cl. C09K 8/035; C09K 8/62; C09K 8/40; C08L 97/02; C08L 1/02; C08L 1/28

(52) U.S. Cl. CPC C09K 8/035; C09K 8/62; C09K 8/40; C08L 2205/16; C08L 1/02; C08L 1/286; C09K 2208/08; C08L 97/02

(57) ABSTRACT

The present invention relates to nanofibrillated cellulose (NFC) for use in drilling fluids, fracturing fluids, spacer fluids etc. The fluids contain NFC as a viscosifier with an aspect ratio of more than 100 and where the nanofibrils have a diameter between 5 and 100 nanometer and a length of more than 1 μm.

### TECHNICAL FIELD

The present invention is directed towards the use of nanofibrillated cellulose (NFC) as viscosity modifier in drilling fluids, fracturing fluids, spacer fluids etc.

### BACKGROUND ART

Macromolecules (polymeric materials), in particular the water-soluble ones, are among the most used chemicals for the extraction of hydrocarbons from subterranean formations. Whether the extraction is primary or tertiary extraction, polymers are used for various functions. For example, in oil and gas well drilling, polymers are used as viscosity modifier, dispersants, or for filtration control purposes. In the case of well stimulation, either by acidizing or hydraulic fracturing, polymers are also used as viscosity modifier and as filtration control additive.

Polymers used in oil extraction are either bio-based or fossil-based materials. Generally, biopolymers is used at low to medium temperature <150° C. Synthetic polymers are used in wider temperature ranges due to their high thermal stability.

Nano-fibrillated cellulose (NFC) is a new class of materials produced from renewable resource and it has a potential as useful additive for oilfield applications. There is great focus to use renewable resources to replace chemicals from petrochemical industry to reduce the carbon footprint. In WO 2014148917 the use of the NFC or micro-fibrillated cellulose (MFC) as viscosifier for oilfield fluids such as fracturing, drilling fluid, spacer fluids and EOR fluids is disclosed. Fluids viscosified with NFC show excellent shear-thinning properties and this is due to the high aspect ratio of the nano-fibrils >100. The aspect ratio of fibril is length divided by diameter of fibril (length/diameter). Additionally, NFC is more thermally stable compared to natural polymers such as xanthan and guar gums, cellulose and starch derivatives, etc. Furthermore, depending on its surface charge, it has high tolerance to salts compared to commercially available biopolymers or synthetic polymers.

NFC can be produced by various processes from any cellulose- or lignocellulose-containing raw materials and its characteristics can be tailor-made. Most of research on NFC is focused on the use of bleached pulp as feedstock to prepare NFC. However, it is economically favorable to use lignocellulosic biomass instead of purified pulp as a feedstock to produce nano-fibrillated lignocellulose, (NFLC). The sources of lignocellulosic biomass are many, such as wood, straw, agricultural waste such as bagasse and beet pulp, etc. This is only applicable, if the end application tolerates the presence of lignin in the final product.

Plant cell wall is composed mainly of lignocellulosic biomass, which consists of cellulose, hemicellulose and lignin. The ratio of these three main components and their structural complexity vary significantly according to the type of plants. In general, cellulose is the largest component in the plant cell wall and it is in the range 35-50% by weight of dry matter, hemicellulose ranges from 15-30% and lignin from 10-30%. As other macromolecules used in oilfield application, the removal of NFLC after the use is desirable. Fortunately, two possible solutions are existing to remove or degrade NFLC by means of enzymatic or oxidative degradation. The enzymatic degradation of lignocellulosic biomass is intensively researched, since it is the main step in biofuel production from biomass. Recent developments achieved a considerable reduction to the overall cost of the enzymatic degradation by optimization the enzyme efficiency, find the best enzymes combination to the targeted biomass, the pretreatment of the biomass to be easily accessible by the enzyme and find the optimal degradation conditions.

NFC or NFLC with wide range of physicochemical properties can be produced, by either selecting the raw materials, or by adjusting the production parameters, or by a post-treatment to the produced fibrils. For example, the dimension of the NFC fibril can be varied to fit for the propose of application. Generally, the diameter of cellulose fiber, that composed of bundles of fibrils, in plants is in the range 20-40 m, with a length in the range of 0.5-4 mm. A single cellulose fibril, which can be obtained by a complete defibrillation of the cellulose fiber, has a diameter of a few nanometers, around 3 nm, and a length of 1-100 m. Depending on the energy input for the defibrillation and the pretreatment prior the defibrillation, the diameter of the fiber can be reduced to an order of magnitude of nanometers (5-500 nm). In addition, the fibril length can be controlled to a certain degree to make it suitable for the desired application. Also, it is well-know from literature that cellulose molecules can be chemically modified in various ways to obtain the desired chemistry. The surface chemistry of NFC in the same way can be tailored to meet the end use needs. Normally, the surface charge of cellulose molecules is neutral with hydroxyl groups on the surface, but the hydroxyl groups are convertible to anionic or cationic charges. The etherification and esterification are among the most used methods to alter the cellulose surface properties.

The nature of NFC allows tailor making its physicochemical properties to match the use in oilfield fluids. Both the fibrils morphology and fibrils' chemistry are adjustable to fit the application requirements.

The thermal stability of NFLC having a high lignin content is not satisfactory. However, NFLC containing up to 20 wt % lignin based on dry matter has an acceptable thermal stability for use in drilling fluids.

Core flooding test is a commonly used method to study the flow of fluid into a porous medium. This test method provide useful information about the interaction of fluids and their components with a core sample representing the target reservoir. This technique is used to assess the formation damage potential of a fluid to oil/gas reservoirs as well to evaluate the penetrability of polymers into a reservoir as in the case of EOR application. The test conditions such as temperature pressure, fluid compositions, core type, and flow rate are set normally to simulate the oilfield and application conditions.

It is an object of the present invention to provide nanofibrillated cellulose for use as an additive for use in drilling fluids, fracturing fluids, spacer fluids etc. where the NFC are not able to penetrate into the formation. For such applications where the fibril penetration into formation is undesirable, such as viscosity modifier or as a fluid loss additive for drilling fluids, spacer fluids, or hydraulic fracturing fluids, it is preferable to use NFC with a long fibril length.

### SHORT DESCRIPTION OF THE INVENTION

The present invention relates to the nanofibrillated cellulose (NFC) for use as a viscosity modifier in drilling fluids, fracturing fluids, spacer fluids etc., wherein the fluids contain NFC with an aspect ratio of more than 100 where the nanofibrils have a diameter between 5 and 50 nanometer and an average length of more than 1 μm.

According to a preferred embodiment the aspect ratio of the NFC is more than 500 where the nanofibrils have a diameter between 5 and 30 nanometer and an average length of more than 5 μm.

According to another preferred embodiment, the nanofibrillated cellulose is nanofibrillated lignocellulose containing up to 20 wt % lignin based on dry matter and preferably up to 10 wt % lignin based on dry matter.

The fibrils dimension can be controlled as follows: The diameter becomes finer and finer by increasing the defibrillation energy used and by using a pretreatment step prior to the defibrillation, to facilitate the defibrillation process. The thinnest fibril diameter is just a few nanometers. According to WO 2012119229 the surface charge (carboxyl group) concentration of NFC can range from 0.1 to 11 mmol per gram of NFC and an aspect ratio in a range from less than 10 to more than 1000 can be obtained.

### FURTHER DESCRIPTION OF THE INVENTION

The NFC materials used in the examples below were produced in the laboratory as described in the literature as follows.
1) TEMPO mediated NFC (TEMPO-NFC) was produced according to the publication of Saito et al. (Saito, T. Nishiyama, Y. Putaux, J. L. Vignon M. and Isogai. A. (2006). Biomacromolecules, 7(6): 1687-1691). TEMPO is 2,2,6,6-tetramethylpiperidine-1-oxyl radical. Generally, TEMPO-NFC has a diameter less than 15 nm and an aspect ratio of more than 100. The charge density is typically in the range 0.2-5 mmol/g.
2) Enzymatic assisted NFC (EN-NFC) was produced according to the publication of Henriksson et al, European polymer journal (2007), 43: 3434-3441 (An environmentally friendly method for enzyme-assisted preparation of microfibrillated cellulose (MFC) nanofibers) and M. Pääkkö et al. Biomacromolecules, 2007, 8 (6), pp 1934-1941, Enzymatic Hydrolysis Combined with Mechanical Shearing and High-Pressure Homogenization for Nanoscale Cellulose Fibrils and Strong Gels. ME-NFC has a diameter less than 50 nm and an aspect ratio of more than 100. The charge density is typically less than 0.2 mmol/g.
3) Mechanically produced MFC (NE-NFC) was produced as described by Turbak A, et al. (1983) “Microfibrillated cellulose: a new cellulose product: properties, uses, and commercial potential”. J Appl Polym Sci Appl Polym Symp 37:815-827. ME-MFC can also be produced by one of the following methods: homogenization, microfluidization, microgrinding, and cryocrushing. Further information about these methods can be found in paper of Spence et al. in Cellulose (2011) 18:1097-1111, “A comparative study of energy consumption and physical properties of microfibrillated cellulose produced by different processing methods”. ME-NFC has a diameter less ca. 50 nm and an aspect ratio of more than 100. The charge density (carboxylate content) is typically less than 0.2 mmol/g.
4) Carboxymethylated NFC (CM-NFC) was produced according to the method set out in “The build-up of polyelectrolyte multilayers of microfibrillated cellulose and cationic polyelectrolytes” Wigberg L, Decher G, Norgen M, Lindstrom T, Ankerfors M, Axnas K Langmuir (2008) 24(3), 784-795. CM-NFC has a diameter less than 30 nm and an aspect ratio of more than 100. The charge density is typically in the range 0.5-2.0 mmol/g.

The equipment used to measure the various properties of the produced NFC included a mass balance, a constant speed mixer up to 12000 rpm, a pH meter, a Fann 35 viscometer, a Physica Rheometer MCR-Anton Paar with Couette geometry CC27, and a heat aging oven (up to 260° C. at pressure of 100-1000 psi) and a core flooding system.

### Example 1

### Core Flooding Tests

Core flooding tests on NFC fluids were performed using different types of cores, both sandstone and limestone, under different conditions such as various NFC concentrations, various types of NFC, at various temperatures, flow rate and different pressures.

The procedure used for the core flooding tests was as follows:

1. The core was dried at 250° F. for 4 hours and weighed to obtain its dry weight. Then the core was saturated with brine solution (5 wt % KCl in deionized water) for 6 hours under vacuum and its wet weight was measured. The pore volume (PV) was calculated using these measurements and the density of the brine solution (density=1.03 g/cm3 at 70° F.).
2. The core was placed inside a core holder. The brine (5 wt % KCl) was pumped through the core in the production direction. If elevated temperature was required, the temperature was raised to the target value (250° F.) and kept constant during the test. The pressure drop across the core was monitored and recorded until it was stabilized. The initial permeability was calculated.
3. The treatment fluid was prepared by diluting 1.0 wt % NFC dispersion with 5 wt % KCl brine to NFC concentration of 0.4 wt %. A 400 g NFC solution was mixed into 600 g KCl brine (5 wt %) to make the 0.4 wt % NFC as a treatment fluid.
4. The treatment fluid containing NFC and/or other chemicals was pumped, in the injection direction (reversed to production direction), at the back pressure of 1100 psi. The pressure drop across the core increased as the fiber fluid was injected. The injection was stopped when 2 PV was injected. The pressure drop across the core was recorded.
5. The direction of flow was then reversed to the production direction and the brine (5 wt % KCl) was injected into the core until the pressure drop across the core was stabilized. The return permeability after fluid treatment was calculated.

### Example 1: Test of ME-NFC Using Cores with Different Permeabilities

In this test, ME-NFC having an aspect ratio above 100 and a diameter of less than 50 nm was tested for core-flooding using sandstone core with permeability of 20, 100, and 400 mD, respectively.

TABLE 1
Test of ME-NFC using various cores. The tests were conducted at 250° F.

| Core flood no. | Test 1 | | Test 2 | | Test 3 | |
|---|---|---|---|---|---|---|
| | Low permeability | | Medium permeability | | High permeability | |
| Core | (20 mD) | | (100 mD) | | (400 mD) | |
| NFC | 0.4% | | 0.4% | | 0.4% | |
| concentration | | | | | | |
| | Pressure | Permeability, | Pressure | Permeability, | Pressure | Permeability, |
| | Drop, psi | mD | Drop, psi | mD | Drop, psi | mD |
| Initial | 81.6 | 20.1 | 21.6 | 75.8 | 8.0 | 409 |
| After Fiber | 93.1 | 17.6 | 24.0 | 68.2 | 15.2 | 215 |

| | | | |
|---|---|---|---|
| Return | 88 | 90 | 53 |
| permeability (%) | | | |

The example above indicates that a regular NFC grade with a diameter of ca. 30 nm and length of more than 5 micrometers poses less or no damage to low and medium permeability cores. The return permeability was above 88% for cores with initial permeability <100 mD. This indicates that NFC fibrils with long fibrils of more than 5 micrometer are large enough to penetrate medium to low permeability formations such as tight gas. It was observed the fibrils were filtered out at the core surface from the injection direction. As the permeability increases, the pore-throat becomes big and nano-fibrils might invade the core. This was the case for the core with an initial permeability of 400 mD where the return permeability was just 53%. This indicates that fibrils penetrated the core and impaired the formation. A post treatment such as enzymatic or chemical breakers is required to remove NFC from the formation.

### Example 2: Test of Various Types of NFC Using Berea Sandstone Core with Medium Permeability (100 mD) and Comparing with Guar Gum and Viscoelastic Surfactant

This example compares the return permeability of 3 types of NFC with guar gum, modified guar gum (hydroxypropyl guar gum) and viscoelastic surfactant as viscosifiers. The treatment fluids were prepared as shown in Table 2.

TABLE 2
Recipes for treatment fluids

| | NFC 1 wt % | KCl 5% brine | Total | |
|---|---|---|---|---|
| | Mass in (gm) | Mass in (gm) | concentration | |
| ME-NFC | 800 | 200 | 0.8 | wt.-% |
| ENZ-NFC | 800 | 200 | 0.8 | wt.-% |
| TEMPO-NFC | 800 | 200 | 0.8 | wt.-% |
| Guar gum | 8 | 992 | 0.8 | wt.-% |
| Modified guar gum | 8 | 992 | 0.8 | wt.-% |
| Viscoelastic surfactant | 40 ml | 960 ml | 4 | vol. % |

TABLE 3
Test of various types of NFC using Berea sandstone core with
medium permeability (100 mD) and comparing with guar gum and
viscoelastic surfactant. The tests were conducted at 250° F.

| Core flood no. | Test 4 | Test 5 | Test 6 | Test 7 | Test 8 | Test 9 |
|---|---|---|---|---|---|---|
| Viscosifier | ME- | ENZ- | TEMPO- | Guar gum | Modified | Viscoelastic |
| | NFC | NFC | NFC | | guar gum | surfactant |
| Concentration | 0.8% | 0.8% | 0.8% | 0.8% | 0.8% | 4 vol % |
| Initial | 75.8 | 79.1 | 89.5 | 74.4 | 83.1 | 81.5 |
| permeability | | | | | | |
| Permeability | 68.2 | 78.4 | 86.6 | 15.8 | 49.9 | 78.7 |
| after fluid | | | | | | |
| injection | | | | | | |
| Return | 90 | 99 | 97 | 21 | 60 | 97 |
| permeability (%) | | | | | | |

This example 2 shows that regardless of the charge density on the surface of the fibrils at the same concentration the return permeabilities were above 90% for medium permeability core such as Berea sandstone. The return permeability for NFC materials was significantly higher than that for guar gum and for modified hydroxypropyl guar gum.

If an enzymatic or chemical pretreatment is used before the defibrillation step to produce NFC, it should be monitored and controlled to avoid shortening the fiber, which can pose damage to the oil & gas reservoir afterword.

1. A fluid containing nanofibrillated cellulose (NFC) as a viscosifier, wherein the fluid is a drilling fluid, a fracturing fluid, or a spacer fluid, wherein the NFC has an aspect ratio of more than 100 and where the nanofibrils have a diameter between 5 and 100 nanometer and a length of more than 1 μm.

2. A fluid as claimed in claim 1, wherein the aspect ratio of NFC is more than 500 and where the nanofibrils have a diameter between 5 and 50 nanometer and a length of more than 5 μm.

3. A fluid as claimed in claim 1, wherein the NFC is nanofibrillated lignocellulose having a lignin content of up to 20 wt % based on dry matter.

4. A fluid as claimed in claim 3, wherein the NFC is nanofibrillated lignocellulose having a lignin content of up to 10 wt % based on dry matter.
